(19) United States
(12) Patent Application Publication
(10) Pub. No.: US 2009/0014188 A1
(43) Pub. Date: Jan. 15, 2009

(54) Device for Containing Ignited Electrical Equipment

(76) Inventors: Christopher R. Hesch, Prior Lake, MN (US); Randy Steenholdt, Savage, MN (US)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 12/033,125

(22) Filed: Feb. 19, 2008

Related U.S. Application Data
(60) Provisional application No. 60/902,923, filed on Feb. 22, 2007.

(51) Int. Cl. A62C 8/00

(52) U.S. Cl. 169/48

(57) ABSTRACT

A device that is capable of containing an ignited lithium ion battery that is contained within an electrical device. The device includes a main body having an opening and a volume sufficient to contain the electrical device and a flap that covers the opening to the main body when the electrical device is contained within the main body. By covering the opening with the flap, the lithium ion battery fire is contained within the device and not allow the fire to spread.

### CROSS-REFERENCE TO RELATED APPLICATION

The present application is based on and claims the benefit of U.S. provisional patent application Ser. No. 60/902,923, filed Feb. 22, 2007, the content of which is hereby incorporated by reference in its entirety.

### BACKGROUND OF THE INVENTION

The present invention generally relates to a device for containing a battery powered electrical equipment. More particularly, the present invention relates to a device that is capable of containing an ignited lithium ion battery within an electrical device.

Many people are utilizing electrical devices such as laptop computers while traveling on mass transit vehicles such as airliners and commuter trains. While most lithium ion batteries contained within the electrical equipment are safe, some have spontaneously ignited on fire due to manufacturing defects or overheating.

A problem with a lithium ion battery fire is that the flame temperature can reach about 1200° F., a temperature that is very difficult to extinguish with conventional equipment. For instance, a typical wet cloth, which would normally be able to smother a typical fire, bums when contacting a fire powered by a lithium ion battery.

Therefore, in the event that a lithium ion battery ignited in a confined space with numerous people within the space, such as an airliner or commuter train, there typically is not the necessary equipment available to extinguish the lithium ion battery fueled fire. As such, the potential results of such a fire could be catastrophic in the event that an airplane could not be safely landed or the commuter train safely stopped in time to evacuate the commuters.

### SUMMARY OF THE INVENTION

The present invention includes a device that is capable of containing an ignited lithium ion battery that is contained within an electrical device. The device includes a main body having an opening and a volume sufficient to contain the electrical device and a flap that covers the opening to the main body when the electrical device is contained within the main body. By covering the opening with the flap, the lithium ion battery fire is contained within the device and not allow the fire to spread.

### BRIEF DESCRIPTION OF THE DRAWINGS

FIG. 1 is a front view of the device of the present invention.

FIG. 2 is a side view of the device of the present invention.

FIG. 3 is a top view of the device of the present invention in an open position.

FIG. 4 is a front view of the device of the present invention having a top flap in an open position.

### DETAILED DESCRIPTION OF ILLUSTRATIVE EMBODIMENTS

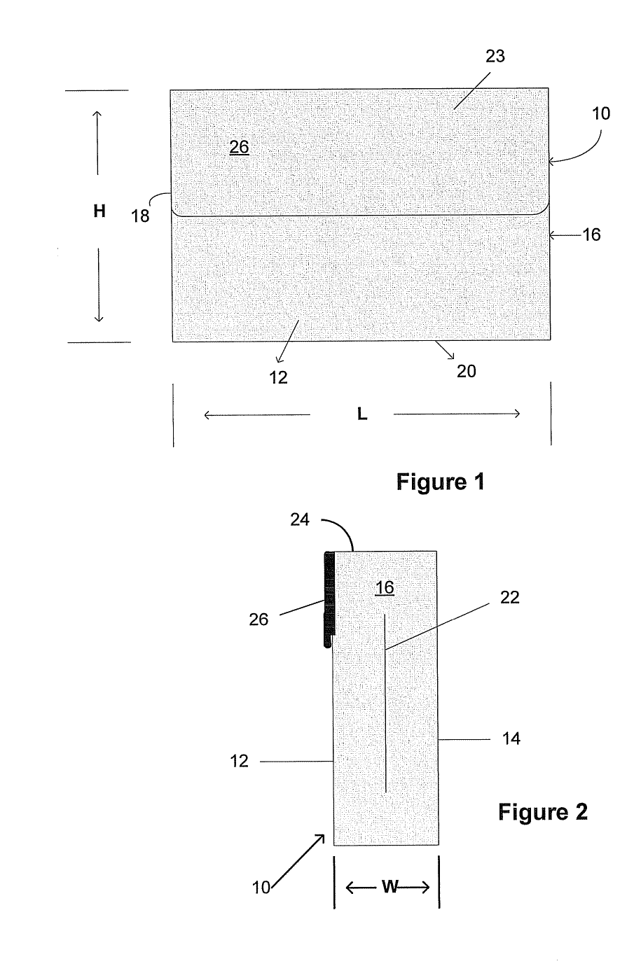

The electronic equipment containment device of the present invention is generally illustrated in FIG. 1 at 10. The electrical containment device is constructed of a material that is capable of withstanding the heat generated by a lithium ion battery fire which can exceed 1200° F. A typical material of construction of the containment device 10 is a textured silica yam fabric such as that sold under the Zetex® Plus trademark manufactured by Newtex Industries, Inc. of Victor, N.Y.

Referring to FIGS. 1 and 2, the containment device 10 includes a front panel 12 and a back panel 14 that is substantially parallel to and the substantially same size as the front panel 12. The front and back panels 12, 14 are connected to each other with a right side panel 16 and a left side panel 18. The device 10 also includes a bottom panel 20 that connects the front and back panels 12, 14 and the left and right side panels 16, 18 at a bottom end of each panel.

Referring specifically to FIG. 2, the right side panel 16 includes a pleat 22 which allows the front panel 12 and the back panel 14 to be positioned proximate each other to reduce the amount of space needed to store the containment device 10. Although not shown in the figures, the left panel 18 and the bottom panel 20 also include a pleat for allowing the front panel 12 and the back panel 14 to be positioned proximate each other to reduce the storage requirements for the device. Reducing the storage requirements is especially important in vehicles where space is extremely limited such as a commuter train or an airplane.

Referring to FIGS. 1, 2 and 4, the containment device 10 includes a flap 23 that extends from the back panel 14 and includes a portion 24 that defines a top panel for the device as well as a flap panel 26 that has one portion 28 of a hook and loop closure mechanism attached to a periphery thereof. The hook and loop closure mechanism is typically a high temperature resistant Velcro® hook and loop closure that mates with the other portion of the hook and loop closure 30 that is secured along the front panel 12 such that when the flap panel 26 is positioned adjacent the front panel 12, the hook and loop closures 28 and 30 mesh to secure the flap panel 26 to the front panel 12. As will be described further in the application, the flap panel 26 is not necessary to practice the present invention. However, the flap panel 26 is a backup feature in the event of failure of other closure device of the present invention.

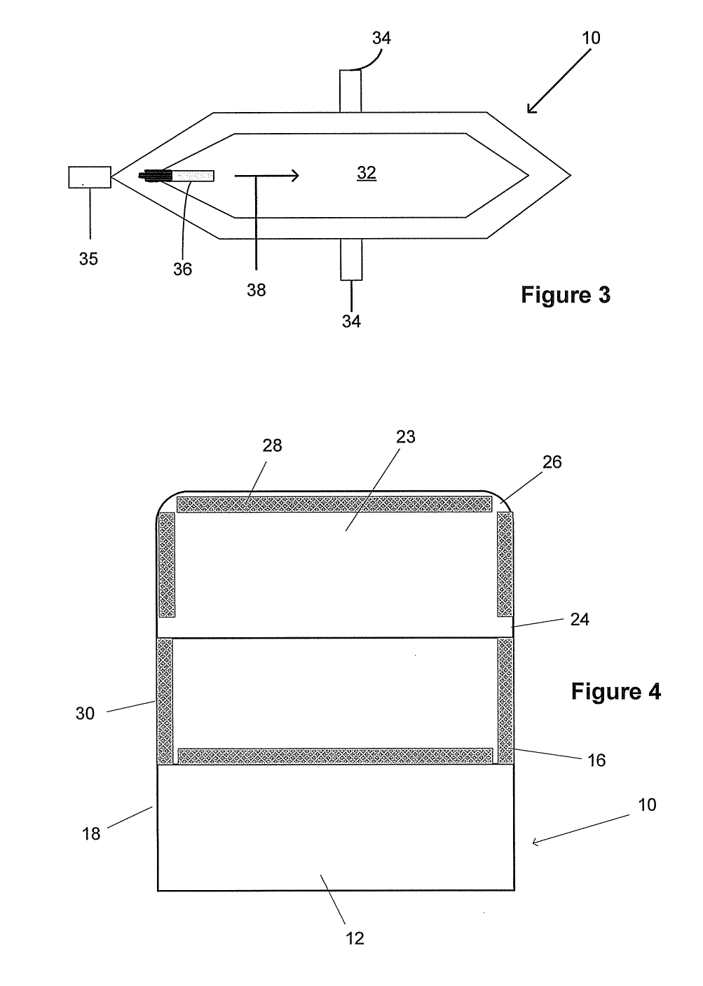

Referring to FIG. 3, the containment device 10 includes a top opening 32 that is sufficiently large enough to accept the largest laptop computer which is positioned into the containment device 10 through the opening 32 either along the length or the width of the electronic device depending upon how the electronic device, such as a laptop computer, is gripped. The containment device 10 includes a spring strap (not shown) contained within the textured silica yarn fabric which is temperature resistant to temperatures in excess of 1500° F. wherein the silica fabric in the front panel 26 and back panels 12, 14 are stitched around the spring strap to prevent the spring strap from melting. The spring strap contained within the device 10 maintains the opening 32 in a position to easily accept an electronic device having the ignited lithium ion battery.

The device 10 also includes pull tabs 34 which are utilized by one person to grip the device 10 and hold the device 10 while another person positions the electronic device through the opening 32. With the electronic device positioned within the device 10 through the opening 32, the person grips the pull tab 35 and a temperature resistant zipper 36 and applies force to the zipper 36 to move the zipper 36 in the direction of arrow 38 to close the opening 32.

The zipper 36 typically includes a Nomex® material and has an aluminized coating that is able to withstand the temperatures of a lithium ion battery fire wherein the aluminized coating is manufactured by Newtex Industries, Inc. of Victor, N.Y. After the zipper 36 closes the opening 32, the electronic device, having the ignited lithium ion battery, is safely contained within the containment device 10 such that the vehicle, such as a commuter train or airplane, can continue on to its final destination.

In the event that the zipper 36 is unable to be closed, the flap panel 26 is positioned into the closed position with a hook and loop closures 28, 30 to minimize the amount of damage that the electronic device with the ignited lithium ion battery can cause.

The containment device 10 typically has a height that is able to accept the longest length of a electronic device, such as a laptop computer as it is uncertain whether the laptop will be inserted lengthwise or heightwise into the containment device 10. By providing an adequate height of the containment device, the people can safely position the electronic device on fire into the containment device 10 without worrying about how the electronic device will fit within the containment device 10.

A typical height H of the containment device 10 is about 21 inches. However, a height greater than 21 inches or less than 21 inches is also within the scope of the present invention.

A typical length L of the containment device 10 is about 30 inches. However, a length L greater than or less than 30 inches is also within the scope of the present invention.

A typical width W of the containment device is about 6 inches in a fully extended position. However, again a width W greater than 6 inches or less than 6 inches is also within the scope of the present invention. What is important is that the device can be easily positioned within the opening 32 without having to realign the ignited electronic device within the opening.

The seams of the containment device 10 are sewn together using a thread which is also able to withstand the at least 1200° lithium ion fire. Typically, the thread is of the same material as the fabric used to manufacture the containment device. It is typical to use a Zetex thread manufactured by Newtex Industries located in Victor, N.Y.

The containment device 10 also typically includes a puncture resistant outer layer such as a para-aramid fiber material such as that manufactured under the Kevlar® trademark by E. I. du Pont & DeNemours, Co. of Wilmington, Del. or Zetex 600 Dyed Fabric manufactured by Zetex Industries, Inc. of Victor, N.Y. The color of the outer shell is typically safety orange. However, any other high visiblity colored fabric is also contemplated.

While the outer layer may not be able to withstand the temperatures of the inner layer, Applicants believe that providing a protective layer outside of the temperature resistant cloth material will prevent the cloth material from being punctured and thereby breaching the containment walls of the device 10. However, the protective layer is not necessary to practice the invention.

At least one pair of gloves that are able to withstand the temperatures created by a lithium ion battery fire are provided along with the device 10. Typically, at least two pairs of gloves are provided along with the containment device 10. The gloves are typically an aluminized Kevlar glove having a leather palm which is manufacture by the Newtex Industries, Inc. of Victor, N.Y. A typical type of glove is a gauntlet style glove which protects the user's forearms.

In operation, in the event that a electronic device starts on fire due to a defective battery, such as a lithium ion battery, the device 10 is removed from the storage and the top flap 23 is positioned in an open configuration which allows the strap spring to expand and open the opening 32 to its widest position. One person dons one set of the gloves and grip the tabs 34 while another person dons the other set of gloves able to withstand the temperatures of the lithium ion battery fire and grabs the electronic device. As one person holds the tab 34, the other person positions the electronic device within the containment device 10 through the opening 32. The person then grips the tab 35 with one hand and grips the zipper handle 36 with the other hand and moves the zipper 36 in the direction of arrow 38 to seal the opening 32.

With the opening 32 sealed, the flap panel 28 is secured to the front panel 12 to provide an additional fire barrier in the event that the zipper 36 would fail for some unforeseen reason.

Although the present invention has been described with reference to preferred embodiments, workers skilled in the art will recognize that changes may be made in form and detail without departing from the spirit and scope of the invention.

What is claimed is:

1. A device for containing an electronic device having a lithium ion battery that is on fire, the device comprising:
a main body having an interior volume and an opening to the interior volume wherein the interior volume is sufficiently sized to accept an electronic device containing a lithium ion battery; and
a flap attached to the main body wherein the flap covers the main body to contain the lithium ion battery fire.
